(19) United States
(12) Patent Application Publication
(10) Pub. No.: US 2021/0015076 A1
(43) Pub. Date: Jan. 21, 2021

(54) Vest for Providing Cooling Temperatures to a Dog

(71) Applicants: Loran Ebarb, Zwolle, LA (US); Linda Anderson-Ebarb, Zwolle, LA (US)

(72) Inventors: Loran Ebarb, Zwolle, LA (US); Linda Anderson-Ebarb, Zwolle, LA (US)

(21) Appl. No.: 16/513,539

(22) Filed: Jul. 16, 2019

(51) Int. Cl. A01K 13/00

(52) U.S. Cl. CPC A01K 13/006

(57) ABSTRACT

The invention relates to a dog vest for providing a cooling sensation to a dog to prevent overheating or heat exhaustion. The dog vest includes a permeable material layer for receiving and distributing a cooling material across a dog's back. The permeable material providing a surface for the cooling material to evaporate thereby lowering the dog's body heat. The invention further includes a pocket placed in proximity of a dog's chest. The pocket is capable of receiving a cooling agent and providing the cooling sensation to the dog's chest.

### FIELD OF THE INVENTION

The present invention relates to apparel for use with pets and more particularly, to a vest that may be used for providing cooling temperatures to a dog.

### BACKGROUND OF THE INVENTION

Unlike people, dogs don't sweat out excess body heat. While dogs do have a few sweat glands located their paws, these do little to help regulate the dog's body temperature. Instead, the dog regulates his body temperature through rapid, open-mouthed breathing, called panting. But sometimes panting isn't enough to keep him from getting overheated.

Heat exhaustion in dogs can occur when the body temperature becomes elevated above the normal temperature. This varies slightly, but it's generally agreed that temperatures of 103 degrees Fahrenheit and higher are above normal. If the temperature continues to rise and reaches 106 or higher, the dog is in the danger zone for heat stroke, during which the organs begin to shut down and his heart could stop altogether.

A means for regulating a dog's body temperature is needed. A preferred means may cool the dog without constant human intervention. The preferred vest may be wearable, and may not restrict the dog's natural movement.

### SUMMARY OF THE INVENTION

An apparatus, and method for using the apparatus, are disclosed which includes various aspects not found in the prior art. The present invention includes a wearable cooling vest for providing a cooling sensation to a dog. In particular, the cooling vest includes a pocket for receiving a cooling agent. When worn, the cooling agent pocket and cooling agent are located in proximity to the dog's chest or abdomen. In this way, the cooling agent may provide a cooling sensation to the dog thereby aiding in regulating the dog's body temperature.

In another aspect, the invention includes an evaporative material placed next to the dog's body. The evaporative material of this invention is suitable for receiving a cooling liquid. The evaporative material for providing a surface to permit the liquid to evaporate from the dog's body. The evaporative process thereby takes a portion of the dog's existing body heat.

According to one aspect of the invention a canine vest for providing cooling temperatures to a dog is taught, which includes:
a. an elongated body portion sized to cover the back of a dog, the elongated body portion further covering a portion of the dog from the neck to the loin, wherein the elongated body portion is comprised of at least a first layer of material, a second layer of material and a third layer of material, wherein the first layer of material is positioned adjacent to the dog's back, the second layer of material is positioned adjacent to the first layer of material, and the third layer of material is positioned adjacent to the second layer of material, and wherein the first layer of material is comprised of neoprene, the second layer of material is comprised of cotton, and the third layer of material is comprised of webbed nylon,
b. A chest portion in communication with the elongated body portion, such that the chest portion and the elongated body portion form an opening for inserting a dog's head therethrough, and
c. A cooling agent pocket formed on an external surface of the chest portion, the cooling agent pocket for receiving a cooling agent, such that the cooling agent may be placed in proximity to the dog's chest.

In another aspect, the present invention teaches a canine vest for providing cooling temperatures to a dog, including:
a. a ring of material for encircling a dog's neck,
b. an elongated body portion sized for covering a dog's back, wherein the elongated body portion is adjacent to the ring of material, the elongated body portion further covering a portion of the dog from the neck to the loin, wherein the elongated body portion is comprised of at least a first layer of material, a second layer of material and a third layer of material, wherein the first layer of material is positioned adjacent to the dog's back, the second layer of material is positioned adjacent to the first layer of material, and the third layer of material is positioned adjacent to the second material, and wherein the first layer of material is comprised of neoprene, the second layer of material is comprised of cotton, and the third layer of material is comprised of webbed nylon,
c. a chest portion in communication with the ring of material, wherein the chest portion includes a chest portion pocket for including a cooling material,
d. a cooling material for inserting into the chest portion pocket.

In another exemplary embodiment the dog vest may include:
a vest for providing cooling temperatures to a dog, including:
   a. a ring of material for encircling a dog's neck,
   b. an elongated body portion sized for covering a substantial portion of a dog's back, wherein the elongated body portion is adjacent to the ring of material, the elongated body portion further covering a portion of the dog from the neck to the loin, wherein the elongated body portion is comprised of at least a first layer of material, and a second layer of material, wherein the first layer of material is positioned adjacent to the dog's back, and the second layer of material is positioned adjacent to the first layer of material, wherein the first layer of material is comprised of one of cotton, webbed nylon, polyester, rayon, rayon-polypropylene, and rayon-polyester.
   c. a chest portion in communication with the ring of material, wherein the chest portion includes a cooling agent pocket for including a cooling material,
   d. a cooling material for inserting into the chest portion pocket

In still another aspect the vest according to the present invention may include:
a ring of material for encircling a dog's neck,
   e. an elongated body portion sized for covering a substantial portion of a dog's back, wherein the elongated body portion is adjacent to the ring of material, the elongated body portion further covering a portion of the dog from the neck to the loin, wherein the elongated body portion is comprised of at least a first layer of material, wherein the first layer of material is positioned adjacent to the dog's back,
   f. a chest portion in communication with the ring of material, wherein the chest portion includes a cooling agent pocket for including a cooling material,
   g. a cooling material for inserting into the chest portion pocket.
wherein the first layer of material is for receiving the cooling material, and wherein the first layer of material is chosen according to the cooling material received and the liquid absorption coefficient of the material relative to the liquid cooling material.

In one aspect, the cooling vest of the present invention includes a chest portion having a chest portion pocket sewn thereon. The chest pocket may be configured to receive a cooling agent therein. Thusly situated, the cooling agent may be placed in proximity to the pet's chest when the cooling vest is worn.

In another aspect of the invention, the cooling vest includes an evaporative layer positioned adjacent to the dog's body. The evaporative later capable of retaining liquid, and permitting the liquid to evaporate.

In still another exemplary embodiment, the evaporative layer may be chosen based on its absorptivity relative to a cooling agent shown.

In another aspect, the cooling vest may include reflectors to reflect light and make the pet more visible when worn at night.

In yet another aspect, the cooling vest may include an accessory pocket on an end of the chest portion opposite the position of the chest portion pocket.

### BRIEF DESCRIPTION OF THE DRAWINGS

A more detailed understanding of the invention may be had from the following description, given by way of example in conjunction with the accompanying drawings wherein like numbered elements represent like elements, and wherein:

FIG. 1 is an example of a pet for which this invention may be used;

FIG. 2 is an exemplary cooing agent for use with exemplary embodiments of the present invention;

FIG. 3 is side view of an exemplary cooling vest according to the exemplary embodiments of the present invention;

FIG. 4 is a view of the underside of an exemplary cooling vest according to the exemplary embodiments of the present invention;

FIG. 5 is affront facing perspective view of an exemplary cooling vest according to the exemplary embodiments of the present invention;

FIG. 6 is an overhead view of an exemplary cooling agent pocket according to the exemplary embodiments of the present invention;

FIG. 7 is an overhead perspective view of an exemplary cooling vest according to the exemplary embodiments of the present invention;

FIG. 8 is a view of the underside of an exemplary cooling vest according to the exemplary embodiments of the present invention illustrating the accessory pocket; and

FIG. 9 is an exploded view of an exemplary cooling vest pocket according to the exemplary embodiments of the present invention.

### DETAILED DESCRIPTION OF A PREFERRED EMBODIMENTS

The present invention is described with respect to the anatomy of a “canine,” or “dog” to facilitate understanding of what is taught. In addition, the invention is described with respect to a cooling agent. The heat exchange action that occurs with using cooling agents to reduce the temperature of skin is not described herein for brevity. For example, it is commonly understood that applying a cooling agent, (like water or ice) to skin will reduce temperature of the skin. It is also commonly known that the evaporative process will also remove body heat skin as the cooling agent evaporates.

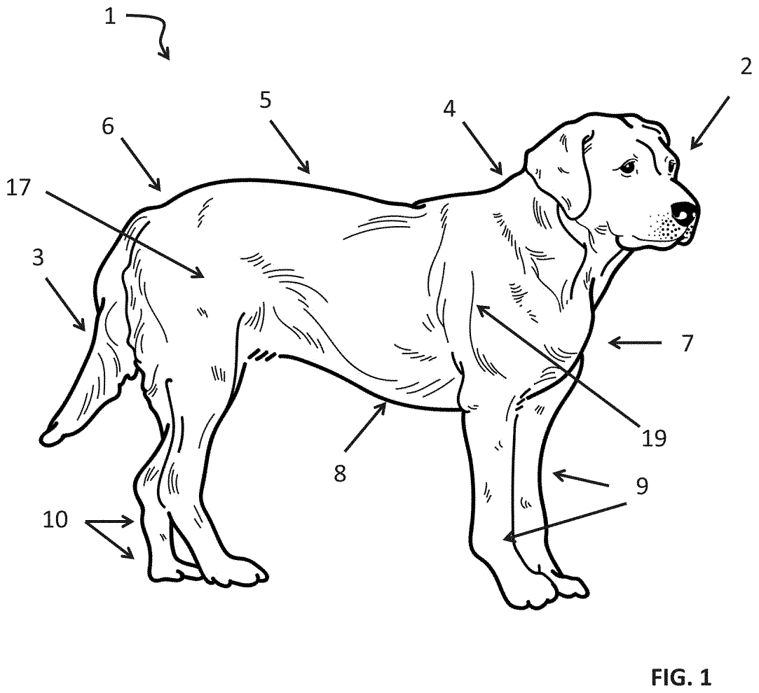

FIG. 1 depicts an exemplary dog 1 with which the invention may be used. A shown, along an upper portion of dog 1, dog 1 may include a dog head 2 attached to a dog neck 4. Dog neck 4 may be further attached to a dog back 5. Dog back 5 may be further attached to dog croup 6. Dog tail 3 may be further attached to dog croup 6.

Along a lower portion of the dog 1, dog head 2 may be further attached to a dog chest 7. Dog chest 7 may be further attached to dog abdomen 8. Dog 1 may further include two forelegs 9 attached in proximity to dog chest 7, and two hind legs 10 attached in proximity to dog croup 6, such that, forelegs 9 and hind legs 10 for supporting the weight of dog 1. Forelegs 9 may be in communication with dog shoulder 19. Dog hind legs 10 are attached to dog upper thigh 17.

It should be noted that the terms used herein to describe parts of dog 1 are the conventional terms and other terms may be used. In some cases, terms are used to identify large sections of the dog's body. For example, as used herein, the abdomen 8 may be also called the belly of the dog. Similarly, dog neck 4 may include a dog's occiput, nape and crest.

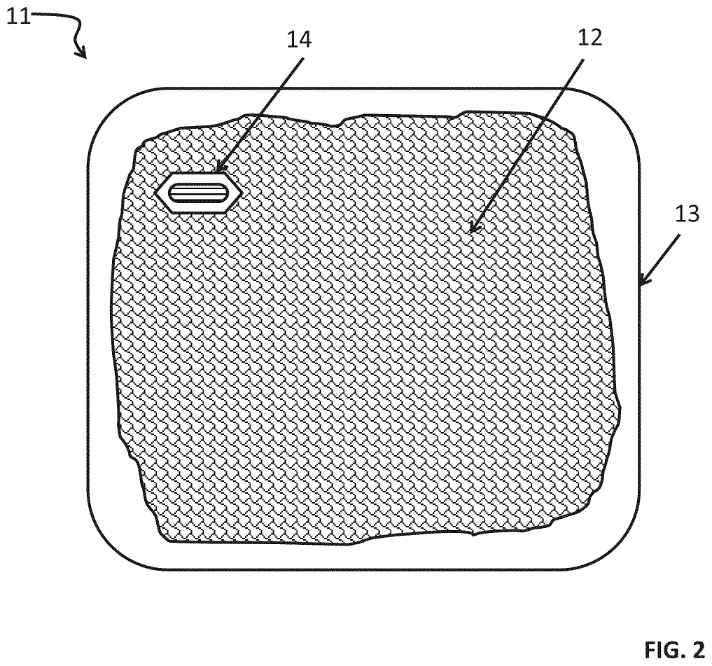

It should also be noted that the present invention is described with respect to using a cooling agent 11, as shown in FIG. 2. As used herein, a cooling agent 11 may be any cooling material that may be contained in cooling agent pocket 110 (described more fully below). For example, cooling agent include a cooling material 12, such as an ice pack, ice, chemical cooling liquid, or the like. In one embodiment, cooling agent 11 may include a cooling agent container 13 for enclosing cooling material 12. In another exemplary embodiment, cooling agent container 13 may be configured such that the cooling material 12, enclosed therein, may be removed, or poured out of container 13. For example, cooling agent container may include a pouch. Cooling agent container 13 may include a resealable spout 14 for use in pouring or removing the cooling material from cooling agent container 13. Resealable spout 114 may be any conventional resealable spout used to control the removal of liquid from a pouch.

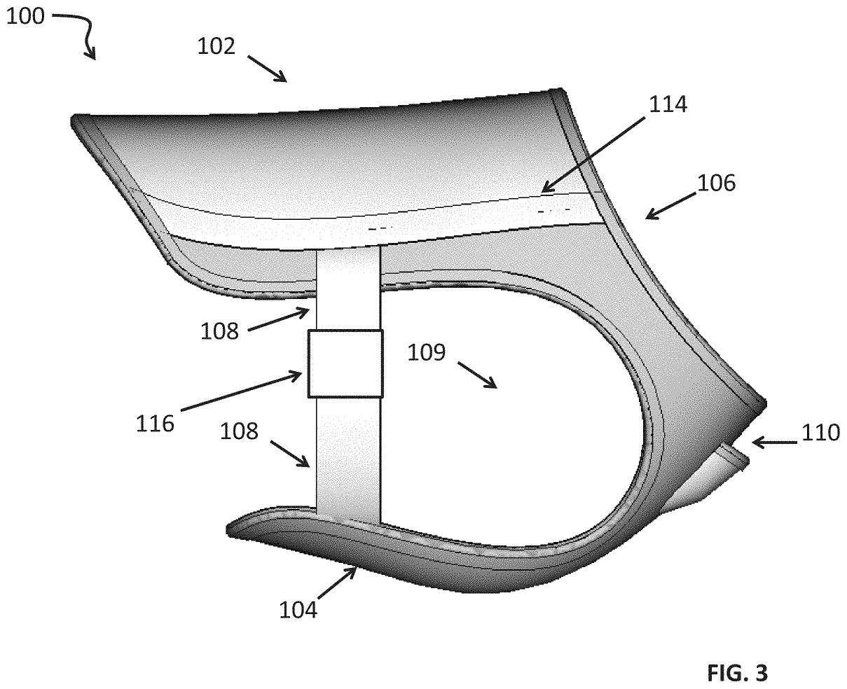

FIG. 3 depicts a side view of a cooling vest 100, an exemplary embodiment of the present invention. As shown, cooling vest 100 includes an elongated body portion 102 configured to overlay or cover a dog back 5. In one exemplary embodiment, elongated body portion 102 may overlay dog back 5 and may extend from dog neck 4 to dog croup 6. Elongated body portion 102, may further include a conventional reflective strip 114 affixed along one side. Reflective strip 114 may be sewn or glued to the surface of elongated body portion 102.

Cooling vest 100 may further include a chest portion 104. In one exemplary embodiment, chest portion 104 may overlay dog chest 7. In another exemplary embodiment, chest portion 104 may overlay dog abdomen 8. In yet another exemplary embodiment, chest portion 104 may overlay chest portion 104 and dog abdomen 8.

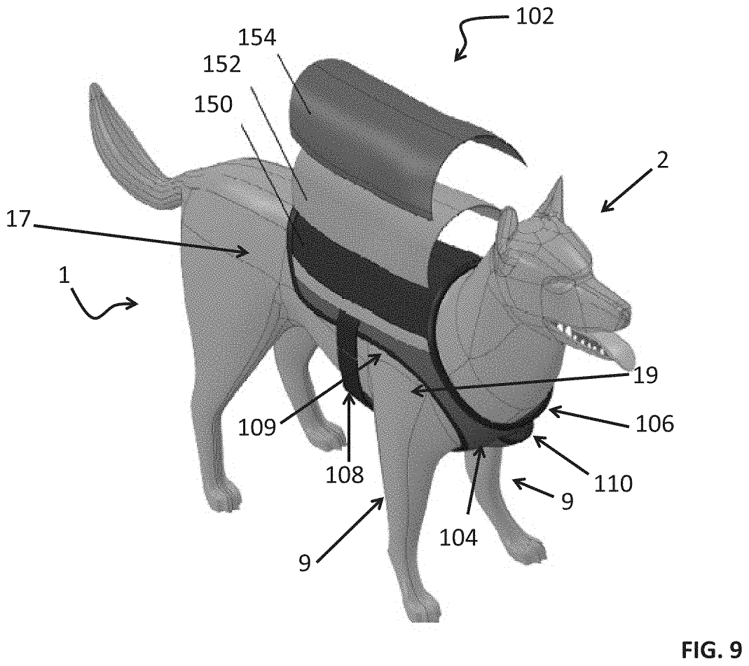

In one exemplary embodiment, elongated body portion 102 may be draped over dog back 5. In another exemplary embodiment, elongated body portion 102 may be draped over a portion of dog back 5. In one exemplary embodiment, elongated body portion 102 may cover dog back 5 and extend in proximity of dog upper arm 19, and in proximity to upper thigh 17. Chest portion 104 may be draped over dog abdomen, but below the proximity of dog upper arm 19, and below dog upper thigh 17. (Shown in FIG. 9)

Cooling vest 100 may further include a strap 108 affixed to elongated body portion 102, and wherein the strap 108 is further affixed to chest portion 104. In one exemplary embodiment, strap 108 may be elongated. In another exemplary embodiment, strap 108 may be formed of multiple pieces.

In one exemplary embodiment, strap 108 may be elastic. In another exemplary embodiment, strap 108 may be adjustable. In yet another exemplary embodiment, strap 108 may include adjusting means 116 for adjusting the distance between elongated body portion 102 and chest portion 104, wherein the distance is measured from the location where strap 108 is affixed to elongated body portion 102 to the location where strap 108 is affixed to chest portion 104. In another exemplary embodiment, adjusting means 116 may be configured to adjust the length of strap 108, such that the area of foreleg opening 109 is also correspondingly adjusted.

For example, where adjusting means 116 facilitates the lengthening of strap 108, then the area of foreleg opening 109 will also increase. Where the adjusting means 116 facilitates the shortening of the length of strap 108, then the area of the foreleg opening 109 will decrease. In one exemplary embodiment, adjusting means 116 may include an adjustable fastener, such as for example, a buckle, a slide buckle, a side release buckle or the like. In another exemplary embodiment, the adjusting means may include a hook and loop material, such as, Velcro®, a snap, clasp or the like.

In another exemplary embodiment, elongated body portion 102, chest portion 104 and strap 108 form a foreleg opening 109 for inserting dog foreleg 9 therein. That is, the area outlined by elongated body portion 102, chest portion 104 and strap 108 forms a suitable passageway (foreleg opening 109) for including dog foreleg 9 therethrough. For completeness, it should be understood that elongated body portion 102, chest portion 104 and strap 108 form a foreleg opening 109 for each of dog forelegs 9.

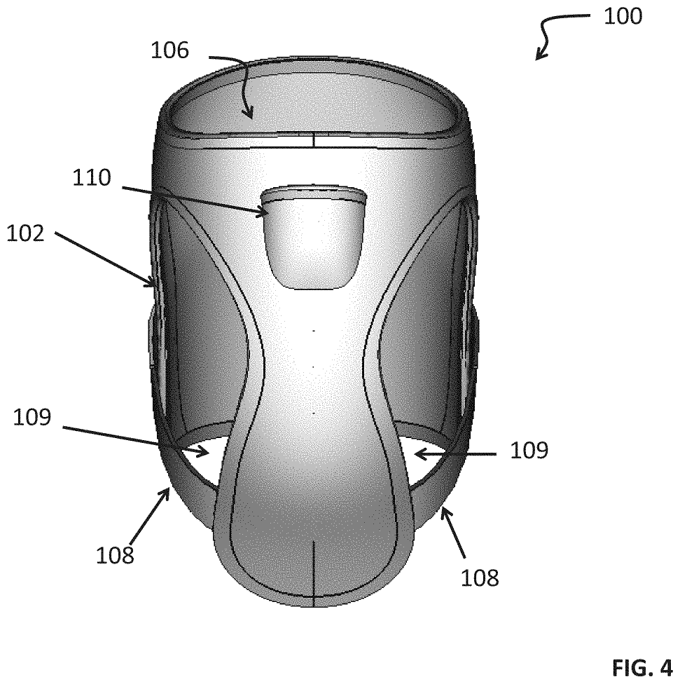

FIG. 4 depicts a view of cooling vest 100 from the bottom. As shown, cooling vest 100 may include a cooling agent pocket 110. Cooling agent pocket 110 may be affixed to an outer surface of chest portion 104. In one exemplary embodiment, cooling agent pocket 110 is sewn to an outer surface of chest portion 104. In another exemplary embodiment, cooling agent pocket 110 may be tacked on, glued on, or affixed in any manner that holds cooling agent pocket 110 in a fixed position relative to chest portion 104. In one preferred embodiment, chest portion pocket 104 extends from dog chest 7 to dog abdomen 8. In another exemplary embodiment chest portion pocket 104 extends from dog chest 7 to in between dog forelegs 9.

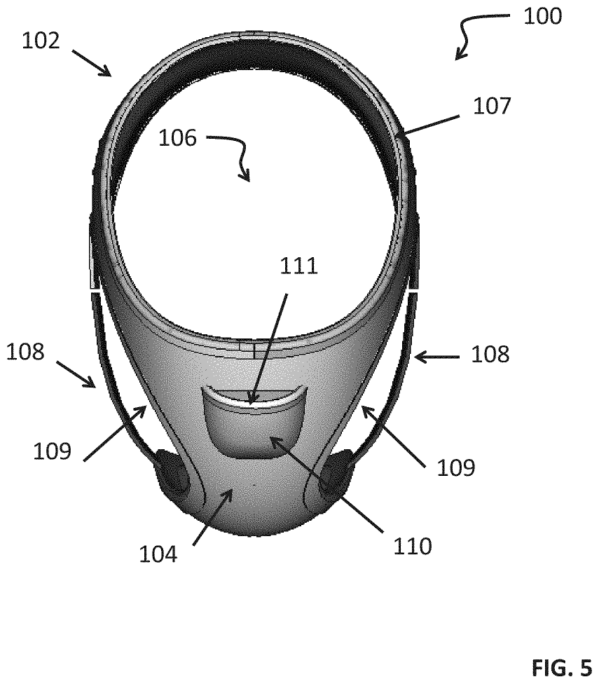

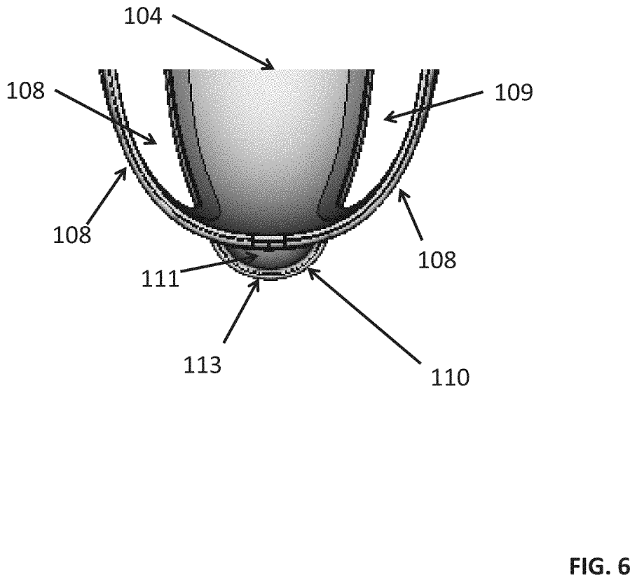

In still another exemplary embodiment shown in FIG. 5 and FIG. 6, cooling agent pocket 110 may be configured to receive a cooling agent into a cooling agent pocket opening 111 therein. FIG. 4 depicts cooling vest 100 in perspective view. FIG. 5 depicts cooling agent pocket 111 in overhead view. As shown, cooling agent pocket opening 111 is such that a cooling agent may be inserted therein.

With continued reference to FIG. 5, cooling vest opening 106, may be framed by a ring of material 107. In such a way, elongated body portion 102 and chest portion 104 may be adjacent to ring of material 107. The ring of material 107 may be configured to provide a cooling vest opening 106 for insertion of dog head 2 when cooling vest 100 is worn. In one exemplary embodiment, elongated body portion 102, ring of material 107, and chest portion 104 may be formed of contiguous material. In another exemplary embodiment, elongated body portion 102 may be formed from one continuous material.

With reference to FIG. 6, chest portion pocket 110 may be sealable and resealable, such that cooling agent may be temporarily stored therein. By sealable, what is meant is that the cooling agent may be enclosed within cooling agent pocket 110. To facilitate the cooling agent being enclosed within cooling agent pocket 110 may include an outer rim 113 capable of being affixed to chest portion 104. Rim 113 may be affixed to chest portion 104 after the cooling agent in included in cooling agent pocket 110, such that the cooling agent is enclosed therein. In one exemplary embodiment, rim 113 may include a zipper, snap, or a hook and loop fabric, such as Velcro®.

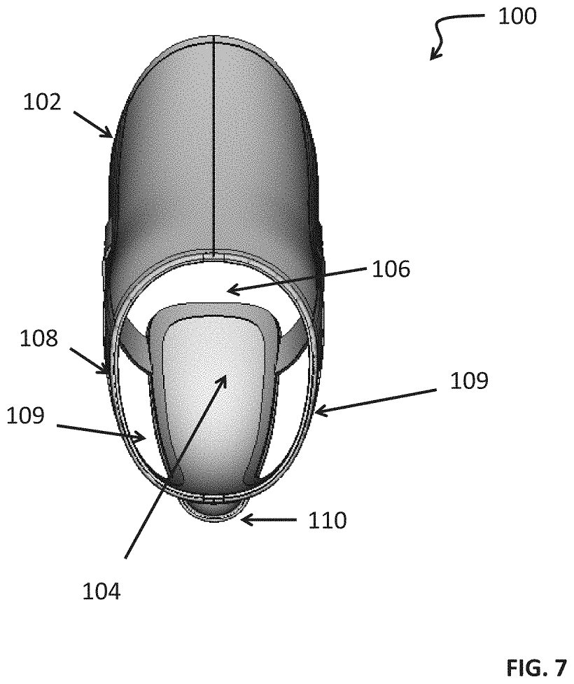

FIG. 7 depicts a perspective view of cooling vest 100, wherein cooling vest opening 106 and foreleg opening 109 are more clearly shown. As can be seen, elongated body portion 102 and chest portion 104 may be configured to provide a cooling vest opening 106 for insertion of dog head 2 when cooling vest 100 is worn. Additionally, elongated body portion 102, chest portion 104 and strap 108 form a foreleg opening 109 for inserting dog foreleg 9 therein.

During use, dog head 2 is inserted into cooling vest opening 106, and dog forelegs 9 are placed into foreleg openings 109. Dog chest 7 may be placed in contact with an upper surface of chest portion 104. As shown, chest portion 104 may include an upper surface that may be placed in contact with dog abdomen 8. Elongated body portion may be placed overlying dog back 5.

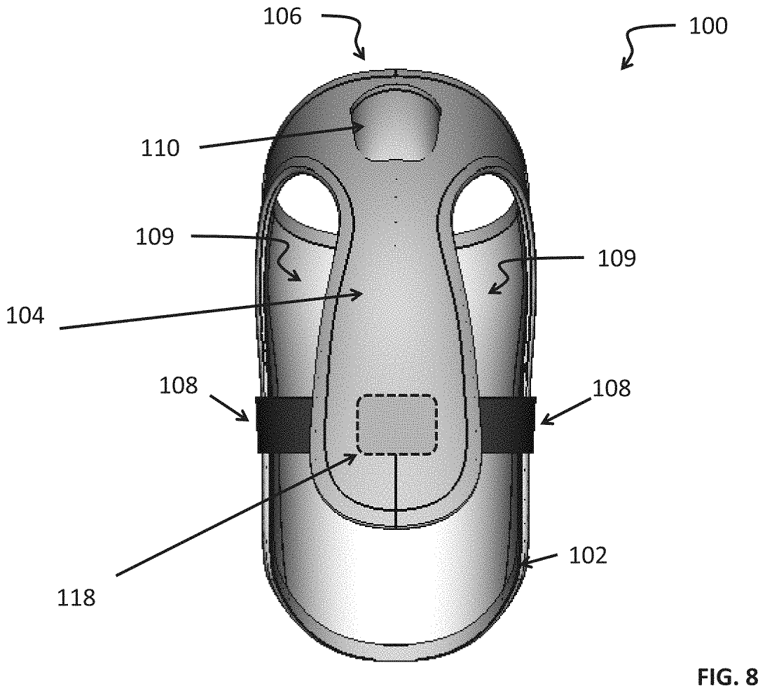

FIG. 8 shows another exemplary embodiment of cooling vest 100 viewed from the bottom. Cooling vest 100 may include an accessory pocket 118. Accessory pocket 118 may be affixed to chest portion 104. Preferably, accessory pocket 118 is positioned on an opposite end of chest portion 104 than is positioned cooling agent pocket 110.

Accessory pocket 118 may be affixed to chest portion 104 using any method suitable for permanently affixing accessory pocket 118, such as sewing, gluing, riveting, snapping, or the like. Accessory pocket 118 may be any conventional pocket that is known for receiving or storing accessories. As uses herein, an accessory may be small items, such as keys, wallet, identification card, jewelry, or the like.

It should be noted that accessory pocket 118 may be constructed of a breathable material. In one embodiment, the breathable material may include one or more layers. The breathable material may be, for example, one of the materials selected from the following group: neoprene, cotton, webbed nylon, and polyester.

FIG. 9 is an illustration of cooling vest 100 in exploded view. Cooling vest 100 is depicted in use on dog 1. As shown, dog head 2 in inserted into cooling vest opening 106. Forelegs 9 are inserted into foreleg openings 109. Elongated body portion 102 rests on dog back 5.

Cooling vest 102 may include one or more multiple material layers 150, 152, 154. Suitable material layers for this invention provide a surface for receiving a cooling agent in liquid form. A suitable agent may be permeable. The material may have a low absorption coefficient. For example, suitable material layer may receive the cooling agent, and spread the surface area of the cooling agent across the suitable material. In this way, the material may be called an “evaporation aiding material.”

In one exemplary embodiment, a suitable material layer may be chosen according to its absorption coefficient, and the cooling agent used to optimize the cooling benefits of the evaporative process. For example, it is well known that the liquid absorption coefficient of a material governs the liquid movement into and out of a material. The liquid absorption coefficient may be calculated according a standard test method, such as ASTM C423 or ISO. Preferred fabrics for use with the invention may have excellent water absorption and transport properties, and have the potential to minimize the wetness sensation on skin, plus facilitate the evaporation of sweat and aid comfort.

Material layers may be chosen from one of a polyester, rayon, rayon-polypropylene, rayon-polyester, neoprene, cotton, or webbed nylon. For example, where 1 layer of material is used, a first layer of material 150 may be webbed nylon. Alternatively, first material layer of material may include neoprene. Where cooling vest 102 includes 2 layers of material, a first layer of 150 may include cotton, while second layer of material 152 includes neoprene. Where cooling vest 102 includes 3 layers of material, first material layer 150 may include cotton, second material layer 152 may include neoprene, and third material layer 154 may include webbed nylon.

The multiple material layers may be conjoined to each other. The material layers may be sewn, fused, tacked, snapped, or the like to each other. In one exemplary embodiment, where cooling vest 100 includes multiple material layers, second material layer 152 may be removably attached to first material layer 150. Similarly, second material layer 152 may be removably attached to third material layer 150.

During operation, a dog owner may place cooling vest 100 onto a dog 1. The dog's forelegs 9 may be placed in foreleg openings 109. Strap 108 may be adjusted to reduce the area of foreleg opening 109, thereby tightening and securing cooling vest 100 to the dog body.

When the dog owner perceives that his dog may be overheating, the dog owner may pour a liquid cooling material 12, such as water, on the material layer 150, 152, 154. Material layer 150, 152, 154 receives the liquid cooling material 12, and permits the cooling agent to distribute or flow throughout the material layer 15, 152, 154. For example, the material chosen by the owner may include a liquid absorption coefficient wherein the rate of distribution of the liquid cooling material throughout the material layer is substantially greater than the absorptivity of the material. That is, the material chosen for material layer 150, 152, 154 may be chosen based on its absorption coefficient relative to the cooling material used. For example, if the owner is using cold water as the cooling material 12, then the owner may choose a material to be used in material layer 150, 152, 154 that permits the maximum rate of evaporation. In this way, the owner may regulate the amount of heat that is pulled away from the dog's body during the evaporation process.

By maximum rate of evaluation, what is meant is that the material permits the maximum amount of distribution of the liquid cooling material before evaporation begins. A more optimum material may permit a greater distribution of liquid cooling material before evaporation than another considered material. In this way, the owner may regulate the rate of evaporation by choosing the material used in the material layers, and the cooling material to be applied to it.

In this way, the liquid material 12 may achieve maximum distribution throughout material layer 150, 152, 154. Consequently, since the material layer 150, 152, 154 is permeable (or porous) then liquid material 12 may come in contact with the dog's skin. The liquid material 12 may then cool the dog's skin that it contacts. In addition, the dog is further cooled as liquid material 12 evaporates from the dog's skin taking heat away the dog's skin.

In another exemplary embodiment, the dog owner may wish to include a cooling agent 11 within cooling agent pocket 100. In which case, the dog owner may insert cooling agent 11 within cooling agent pocket 110. The cooling agent 11 may be removably sealed in cooling agent pocket by securing cooling agent pocket rim 111 to cooling vest chest portion 104. In this way, the cooling agent 11 transfers it cooling sensation to the chest 7 of dog 1.

It should be noted that various embodiments of the invention are described with respect to the individual elements of the invention.

We claim:

1. A vest for providing cooling temperatures to a dog, including:
a. an elongated body portion sized to cover the portion of the dog from the neck to the loin, wherein the elongated body portion is comprised of at least a first layer of material, wherein the first layer of material is positioned adjacent to the dog's back,
b. a chest portion in communication with the elongated body portion, such that the chest portion and the elongated body portion form an opening for inserting a dog's head therethrough,
c. a cooling agent pocket affixed to an external surface of the chest portion, the cooling agent pocket being affixed on a first end of the chest portion in proximity to the dog's chest, and wherein the cooling agent pocket is configured to receiving a cooling agent therein, such that the cooling agent may be placed in proximity to the dog's chest.

2. A vest according to claim 1, wherein the first layer of material is for receiving a liquid cooling material, and wherein the first layer of material is chosen according to the liquid cooling material received and the liquid absorption coefficient of the material relative to the liquid cooling material.

3. A vest according to claim 0, further including a cooling agent for insertion into the cooling agent pocket.

4. A vest according to claim 0, further comprising an elongated strap affixed to the elongated body portion and the chest portion, such that the elongated strap, elongated body portion and the chest portion form a foreleg opening for insertion of a dog's foreleg.

5. A vest according to claim 4, wherein the elongated strap includes adjustable means for adjusting the area of the foreleg opening.

6. A vest according to claim 4, wherein the elongated strap is adjustable.

7. A vest according to claim 1, further comprising an elongated reflective strip affixed to one side of the elongated body portion.

8. A vest according to claim 1, further comprising an accessory pocket affixed to the chest portion, the accessory pocket being positioned on a second end of the chest portion, wherein the first end of the chest portion is substantially opposite second end of the chest portion.

9. A vest for providing cooling temperatures to a dog, including:
a. a ring of material for encircling a dog's neck,
b. an elongated body portion sized for covering a substantial portion of a dog's back, wherein the elongated body portion is adjacent to the ring of material, the elongated body portion further covering a portion of the dog from the neck to the loin, wherein the elongated body portion is comprised of at least a first layer of material, and a second layer of material, wherein the first layer of material is positioned adjacent to the dog's back, and the second layer of material is positioned adjacent to the first layer of material, wherein the first layer of material is comprised of one of cotton, webbed nylon, polyester, rayon, rayon-polypropylene, and rayon-polyester.
c. a chest portion in communication with the ring of material, wherein the chest portion includes a cooling agent pocket for including a cooling material,
d. a cooling material for inserting into the chest portion pocket.

10. A vest according to claim 9, further comprising a restraining strap affixed to the elongated body portion and the chest portion, such that the restraining strap, elongated body portion and the chest portion form an aperture for insertion of the dog's foreleg.

11. A vest according to claim 10, wherein the restraining strap is comprised of elastic material.

12. A vest for providing cooling temperatures to a dog according to claim 10, wherein the restraining strap is adjustable.

13. A vest according to claim 9, wherein the first layer of material is chosen according to the cooling material received and the liquid absorption coefficient of the material relative to the cooling material.

14. A vest for providing cooling temperatures to a dog, including:
a. a ring of material for encircling a dog's neck,
b. an elongated body portion sized for covering a substantial portion of a dog's back, wherein the elongated body portion is adjacent to the ring of material, the elongated body portion further covering a portion of the dog from the neck to the loin, wherein the elongated body portion is comprised of at least a first layer of material, wherein the first layer of material is positioned adjacent to the dog's back,
c. a chest portion in communication with the ring of material, wherein the chest portion includes a cooling agent pocket for including a cooling material,
d. a cooling material for inserting into the chest portion pocket.
wherein the first layer of material is for receiving the cooling material, and wherein the first layer of material is chosen according to the cooling material received and the liquid absorption coefficient of the material relative to the liquid cooling material.

15. A vest according to claim 04, further comprising an elongated strap affixed to the elongated body portion and the chest portion, such that the elongated strap, elongated body portion and the chest portion form a foreleg opening for insertion of a dog's foreleg.

16. A vest according to claim 15, wherein the elongated strap includes adjustable means for adjusting the area of the foreleg opening.

17. A vest according to claim 15, wherein the elongated strap is adjustable.

18. A vest according to claim 14, further comprising an elongated reflective strip affixed to one side of the elongated body portion.

19. A vest according to claim 14, further comprising an accessory pocket affixed to the chest portion, the accessory pocket being positioned on a second end of the chest portion, wherein the first end of the chest portion is substantially opposite second end of the chest portion.
